(19) United States
(12) Patent Application Publication
(10) Pub. No.: US 2011/0088497 A1
(43) Pub. Date: Apr. 21, 2011

(54) UNIFIED POSITIONING CONTROL MECHANISM FOR TWO TELESCOPING RODS

(76) Inventor: Chao-Ken Chen, Changhua County (TW)

(21) Appl. No.: 12/891,813

(22) Filed: Sep. 28, 2010

(30) Foreign Application Priority Data
Oct. 16, 2009 (TW) 098219081

(51) Int. Cl. G05G 9/00

(52) U.S. Cl. 74/471 R

(57) ABSTRACT

A control device for unifiedly positioning two symmetric and parallel telescoping rods is disclosed. The control mechanism includes a first controller mounted on a first telescoping rod and a second controller mounted on a second telescoping rod. Each controller controls a pin to position one of the telescoping rods. A linking rod is disposed between the two controllers for unified motion. A torque element is disposed in the first controller. When the first controller is triggered by a cord, the pins will be separately inserted in the telescoping rods for locking. When releasing the cord, the pins will run back to the initial position by the force from the torque element so that the telescoping rods are released for providing a length adjustment.

### BACKGROUND OF THE INVENTION

1. Technical Field

The invention relates to telescoping rods standing something, particularly to mechanisms for positioning the telescoping rods.

2. Related Art

To satisfy demands of users, some of furniture is designed to have a function of adjustable length or height, such as chairs or tables. Those adjustable chairs and tables can be adjusted to fit for different users to use.

In order to adjust height of a tabletop, a telescoping stand must be installed under the tabletop. When the tabletop has been set to a desired height, a positioning device is needed to firmly position the tabletop. USPAP No. 2008/0156962, which was invented by the inventor, provides an available solution for adjustable tabletop stand. This invention can provide the required function, but there still are insufficiencies. For example, two positioning devices are separately and independently disposed on two telescoping rods of the telescoping stand without any connection, so they must be individually operated for height adjustment. Moreover, the positioning devices are located under the tabletop, so a user must stoop down or squat down to operate when he or she is adjusting and locking height of the tabletop. This is considerably inconvenient for users.

### SUMMARY OF THE INVENTION

An object of the invention is to provide a unified positioning control mechanism for two telescoping rods, which can unifiedly adjust height of the tabletop instead of individual operation so as to be convenient for users.

To accomplish the above object, the control mechanism of the invention includes a first controller mounted on a first telescoping rod and a second controller mounted on a second telescoping rod. Each controller controls a pin to position one of the telescoping rods. A linking rod is disposed between the two controllers for unified motion. A torque element is disposed in the first controller. When the first controller is triggered by a cord, the pins will be separately inserted in the telescoping rods for locking. When releasing the cord, the pins will run back to the initial position by the force from the torque element so that the telescoping rods are released for providing a length adjustment.

In other words, the operation to the first controller can conjointly work the second controller. Additionally, the first controller is driven by a cord, so a user needn't stoop down or squat down to operate if a tail end of the cord is put on the table. Thus the problem of the prior art can be efficiently solved by the invention.

### BRIEF DESCRIPTION OF THE DRAWINGS

FIG. 1 is a schematic view of the invention applied in a table;

FIG. 2 is a front plan view of FIG. 1;

FIG. 3 illustrates the first controller and the first telescoping rod;

FIG. 4 illustrates the first controller mounted on the first telescoping rod with the cord and trigger;

FIG. 5 is a schematic view of the operation of the trigger and the first controller; and

FIG. 6 is a schematic view depicting the height adjustment of the invention.

### DETAILED DESCRIPTION OF THE INVENTION

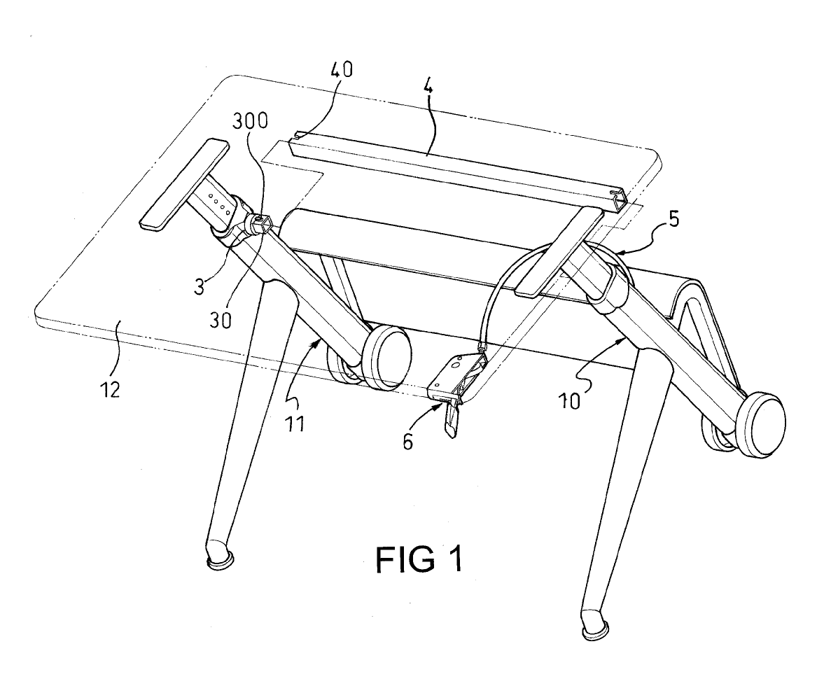

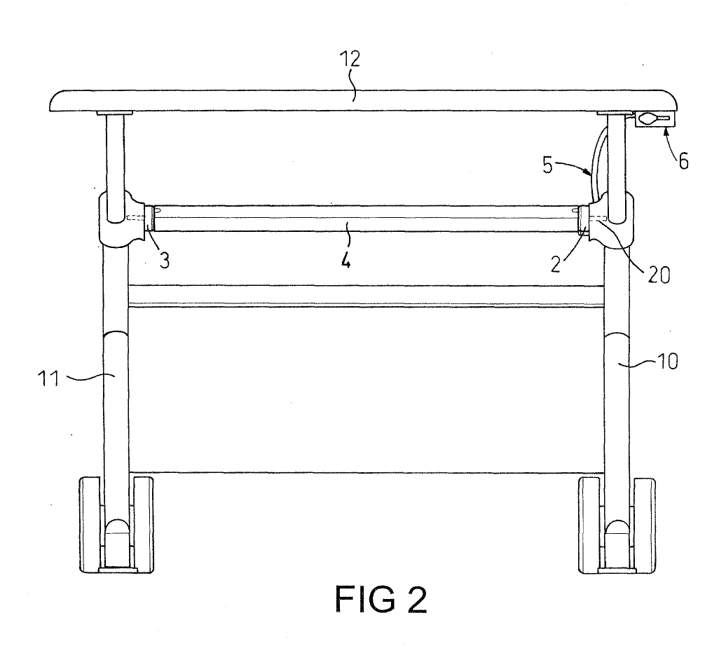

Please refer to FIGS. 1-4. The control mechanism of the invention is used for unifiedly controlling two axially parallel and symmetric telescoping rods 10, 11 such as .a table stand shown in the drawings. The table stand is installed under the tabletop 12 for support with height adjustment.

A first controller 2 and a second controller 3 are mounted on the first telescoping rod 10 and the second telescoping rod 11, respectively. A linking rod 4 is provided between the two controllers 2, 3 for cooperative connection. The first controller 2 is provided with a cord 5 by which the first controller 2 may be activated. An inner end of the cord 5 is connected to a trigger 6. The trigger 6 may be fixed on the tabletop 12 or preferably on the bottom side near the front edge of the tabletop 12 for more convenient operation. More preferably, the cord 5 may be sheathed in a tube 50. The tube 50 can not only protect the cord 5 but also be fastened easily.

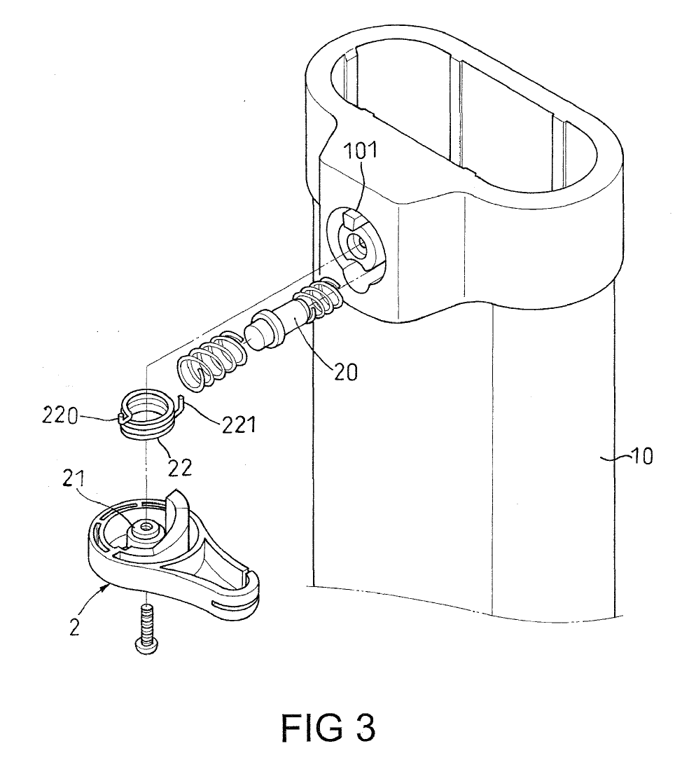

FIG. 3 illustrates the structure of the first controller 2 and the relationship with the first telescoping rod 10. Also, the structure of the second controller 3 and the relationship with the second telescoping rod 11 are the same as the first controller's 2. The first controller 2 is provided with a hole 101 for being inserted by a pin 20. Also, the first controller 2 is rotatably fixed in the hole 101 through the pin 20. When the first controller 2 is driven to rotate, the pin 20 is inserted into the inside of the first telescoping rod 10 for locking the first telescoping rod 10 in a desired length. As to the structure of the pin 20 and first controller 2, please refer to the disclosure of U.S. patent application publication No. 2008/0156962 because they are the same. A post 21 is disposed in the first controller 2 for being positioned by a torque element 22 such as a torque spring. Two opposite terminals of the torque element 22 bear against the first controller 2 and the first telescoping rod 10, respectively. The torque element 22 generates torque when the first controller 2 is driven, i.e. when the pin 20 is locking the first telescoping rod 10.

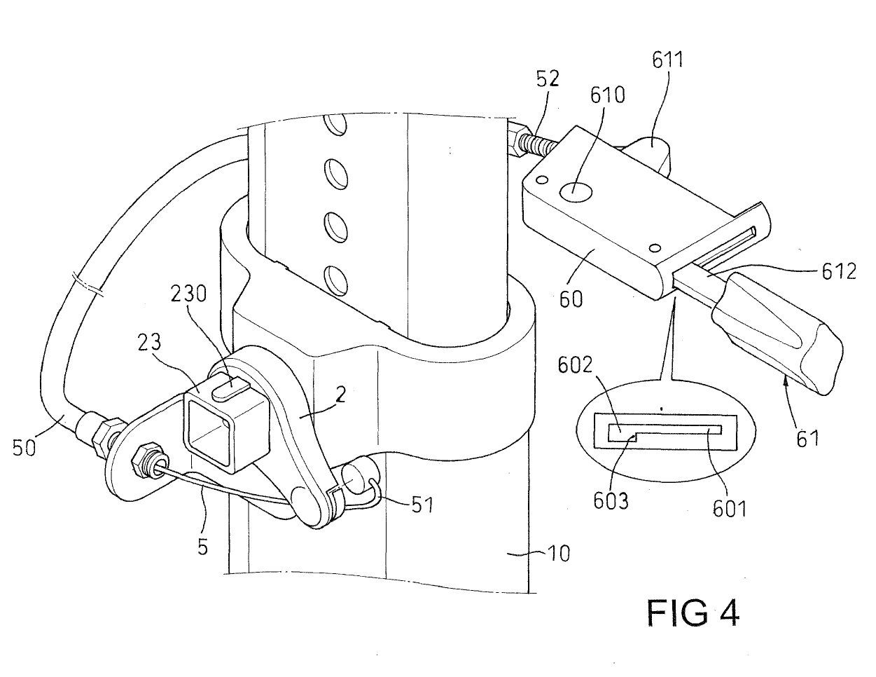

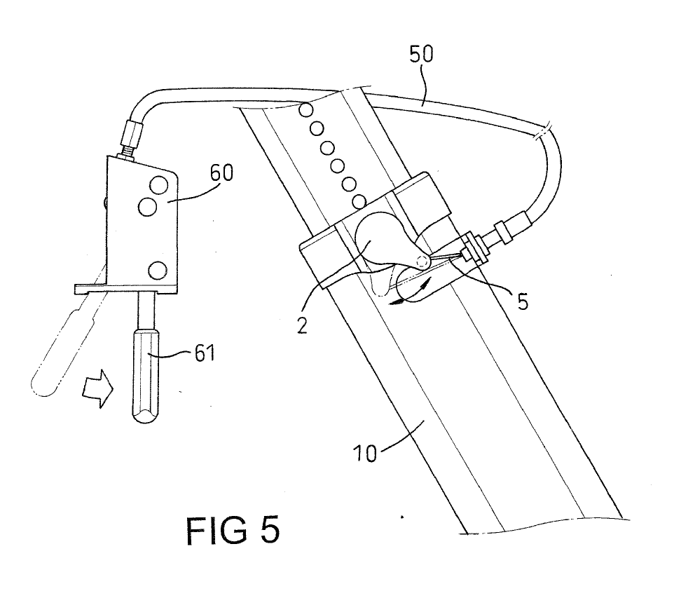

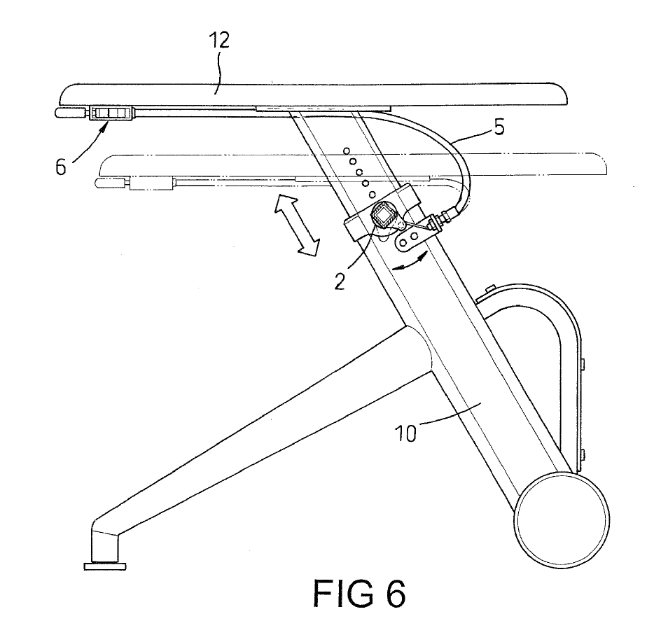

FIG. 4 illustrates the first controller 2 on the first telescoping rod 10 with the trigger 6 and cord 5. The cord 5 is connected between the first controller 2 and the trigger 6. The trigger 6 is provided with a mount portion 60 and an operation portion 61. A first position 601 and a second position 602 are defined in the mount portion 60 for being operated therein by the operation portion 61. Additionally, a holding portion 603 is defined in the second position 602 for holding the operation portion 61. The operation portion 61 is pivotally fixed in the mount portion 60 through a shaft 610. One end of the operation portion 61 is provided with a connection portion 611 connecting the cord 5. The other end of the operation portion 61 may be set at the first position 610 or the second position 602. Preferably, the connection portion 611 and the operation portion 61 are not arranged in line. Please further refer to FIG. 5. When the operation portion 61 is moved from the first position 601 to the second position 602, the connection portion 611 pulls the cord 5 because of positional shift, and the first controller 2 is rotated to insert the pin 20 into the first telescoping rod 10 for locking the first telescoping rod 10 at a desired position. Meanwhile, the operation portion 61 is held in the holding portion 603 and the torque element 22 is twisted. Contrarily, when the operation portion is moved from the second position 602 to the first position 601, the first controller 2 cease to pull the cord 5 and the twisted torque element 22 is released to reversely rotate the first controller 2. Finally, the pin 20 is moved out of the first telescoping rod 10. As can be seen in FIG. 6, a user may adjust the first and second telescoping rod 10, 11 to a desired position and then operate the trigger 6 to lock them.

When the first telescoping rod 10 and the second telescoping rod 11 are employed to support the tabletop as shown in FIG. 1, because the height adjustment of the tabletop 12 must conjointly move these two telescoping rods 10, 11, the two controllers 2, 3 also must be conjointly activated. As abovementioned, the linking rod 4 is connected between the two controllers 2, 3. Please refer to FIGS. 1 and 4. The first controller 2 is formed with a first sleeve seat 23 towards the second telescoping rod 11 for accommodating the linking rod 4. And the first sleeve seat 23 is provided with a first protrusion 230. Correspondingly, the second controller 3 is formed with a second sleeve seat 30 towards the first telescoping rod 10, and the second sleeve seat 30 also has a second protrusion 300. Preferably, the two sleeve seats 23, 30 may be of any shape except a circle. Two opposite ends of the linking rod 4 are separately accommodated in the two sleeve seats 23, 30. As a result, the second controller 3 can be conjointly activated when the first controller 2 is driven. Additionally, two ends of the linking rod 4 are separately provided with two slots 40 corresponding to the protrusions 230, 300. By inserting the protrusions 230, 300 into the slots 40, the linking rod 4 can be guaranteed to move with the two sleeve seat 23, 30. This can prevent the sleeve seats 23, 30 from idling and failing to rotate the linking rod 4.

While the forgoing is directed to a preferred embodiment of the present invention, other and further embodiments of the invention may be devised without departing from the basic scope thereof. As such, the appropriate scope of the invention is to be determined according to the claims.

What is claimed is:

1. A positioning control mechanism for unifiedly controlling two parallel and symmetric telescoping rods, comprising:
a first controller mounted on a first telescoping rod,
a cord having a first end and a second end, the first end connecting to the first controller, wherein the first controller can be rotated by pulling the cord;
a trigger connecting to the second end of the cord;
a first torque element, mounted in the first controller, two opposite terminals of which separately bear against the first controller and the first telescoping rod, wherein the first torque element is deformed when the first controller is driven;
a second controller mounted on a second telescoping rod;
a second torque element, mounted in the second controller, two opposite terminals of which separately bear against the second controller and the second telescoping rod, wherein the second torque element is deformed when the second controller is driven; and
a linking rod connecting between the first controller and the second controller for having the first controller and the second controller conjointly move.

2. The positioning control mechanism of claim 1, wherein the trigger is provided with a mount portion and an operation portion, a first position and a second position are defined in the mount portion for being operated therein by the operation portion, and the second position is further defined with a holding portion.

3. The positioning control mechanism of claim 2, wherein the operation portion is pivotally fixed in the mount portion through a shaft, one end of the operation portion is provided with a connection portion connecting the cord, and the other end of the operation portion is set at the first position or the second position.

4. The positioning control mechanism of claim 3, wherein the connection portion and the operation portion are not arranged in line.

5. The positioning control mechanism of claim 1, wherein the first controller is formed with a first sleeve seat towards the second telescoping rod, the first sleeve seat is provided with a first protrusion, the second controller is formed with a second sleeve seat towards the first telescoping rod, the second sleeve seat has a second protrusion, two ends of the linking rod are separately provided with two slots corresponding to the protrusions, and two opposite ends of the linking rod are separately accommodated in the two sleeve seats with inserting the protrusions into the slots.

6. The positioning control mechanism of claim 1, wherein the first controller is formed with a first sleeve seat towards the second telescoping rod for accommodating the linking rod, the second controller is formed with a second sleeve seat towards the first telescoping rod for accommodating the linking rod, the two sleeve seats are of any shape except a circle, and two opposite ends of the linking rod are separately accommodated in the two sleeve seats.
